(19) United States
(12) Patent Application Publication
(10) Pub. No.: US 2013/0248512 A1
(43) Pub. Date: Sep. 26, 2013

(54) HEATING ASSEMBLY AND METHOD THEREOF

(71) Applicant: CUSTOM MACHINING SERVICES, INC., Valparaiso, IN (US)

(72) Inventors: Joseph V. Intagliata, Hanna, IN (US); Joshua Ruge, Valparaiso, IN (US); Jeffrey Robin Intagliata, Wanatah, IN (US)

(73) Assignee: Custom Machining Services, Inc., Valparaiso, IN (US)

(21) Appl. No.: 13/849,100

(22) Filed: Mar. 22, 2013

Related U.S. Application Data
(60) Provisional application No. 61/614,113, filed on Mar. 22, 2012.

(51) Int. Cl. H05B 3/58; B23P 19/02

(52) U.S. Cl. CPC H05B 3/58; B23P 19/02
USPC 219/523; 29/447

(57) ABSTRACT

A method and apparatus suitable for safely and efficiently heating a hose for insertion therein of an attachment. The apparatus includes a heating assembly having at least one hose heater including an electric heating element. The hose heater is adapted to be collapsed, inserted, and expanded into an end of the hose to increase the temperature of the end of the hose.

### CROSS REFERENCE TO RELATED APPLICATIONS

This application claims the benefit of U.S. Provisional Application No. 61/614,113, filed Mar. 22, 2012, the contents of which are incorporated herein by reference.

### BACKGROUND OF THE INVENTION

The present invention generally relates to methods and apparatuses for industrial hose assemblies. More particularly, this invention relates to a hose heating apparatus which is capable of safely and efficiently heating a hose for insertion of a stem, fitting, or other attachment.

Hose attachments, such as stems and fittings, are commonly attached to an end of a hose for a variety of applications, such as providing an interface between the hose and another device. The attachments are often inserted into the end of the hose and secured therein. In order to insert the attachment into the hose, the hose may need to be heated to thermally expand an end of the hose to provide an opening capable of mating with the attachment. In the past, primary options for insertion of attachments into hoses, such as thermoplastic hoses, have included the use of either immersion in a heated liquid, particularly water, or direct heating with a torch, such as an asphalt torch, for heating of the hose prior to insertion of the stem or fitting.

The use of heated liquid can be problematic in that the operator may be exposed to multiple hazards. Those hazards include the heated liquid, the temperature of the vessel containing the heated liquid, any flame or other heat source used to heat the liquid, and/or possible fumes generated by the heat source.

The use of a torch can also be hazardous, particularly due to the flame that the torch emits while operating the torch, but also the residual heat that lingers after the flame is extinguished. Also, the operator may be exposed to noxious fumes associated with the use of this method.

Accordingly, there is a need for a means for heating industrial hoses for the purpose of inserting of a stem, fitting, or other attachment through a process capable of overcoming shortcomings of the prior art, and particularly, capable of providing enhanced safety to the operator while effectively heating the hose to a desired temperature.

### BRIEF DESCRIPTION OF THE INVENTION

The present invention provides a method and apparatus suitable for safely and efficiently heating a hose for insertion therein of an attachment.

According to a first aspect of the invention, a heating assembly for inserting an attachment into an end of a hose includes at least one hose heater comprising an electric heating element. The hose heater is adapted to be collapsed, inserted, and expanded into an end of the hose to increase the temperature of the end of the hose.

According to a second aspect of the invention, a method of inserting an attachment into an end of a hose includes applying a source of heat to an inner surface of the end of the hose to cause thermal expansion thereof and applying a physical force to the inner surface of the end of the hose to cause physical expansion thereof resulting in expansion of the end of the hose to a suitable inner diameter of the hose to mate with the attachment and inserting the attachment into the end of the hose.

According to a third aspect of the invention, a method of inserting an attachment into an end of a hose includes collapsing a hose heater comprising an electric heating element. The hose heater is inserted into the end of the hose and released causing the hose heater to expand and apply a physical force to the inner surface of the end of the hose. The electric heating element thermally contacts an inner surface of the end of the hose. The hose is heated with the electric heating element and then the hose heater is removed from the hose. The attachment is inserted into the end of the hose.

A technical effect of the invention is the ability to provide enhanced safety to an operator while effectively heating a hose to a predetermined temperature. In particular, it is believed that, an operator can heat a hose without being exposed to the hazards associated with heated liquid or flame.

Other aspects and advantages of this invention will be better appreciated from the following detailed description.

### BRIEF DESCRIPTION OF THE DRAWINGS

FIG. 1 is a perspective view representing an industrial hose and a heating assembly in accordance with an aspect of this invention.

FIG. 2 contains two perspective views representing a hose heater of the heating assembly of FIG. 1 prior to insertion and after insertion into a hose in accordance with an aspect of this invention.

FIG. 3 is a perspective view representing multiple hose heaters in accordance with aspects of this invention.

FIG. 4 includes a plan view representing a flat pattern used to form a rolled sleeve of the hose heater of FIGS. 1-3, and perspective, end, and detailed views of a rolled sleeve in accordance with aspects of this invention.

FIG. 5 includes plan and side views representing a flat electric heating element suitable for use in combinations with the rolled sleeve to form a hose heater in accordance with aspects of this invention.

FIG. 6 is a perspective view representing a controller in accordance with an aspect of this invention.

### DETAILED DESCRIPTION OF THE INVENTION

The present invention is generally applicable to methods of heating hoses, such as thermoplastic hoses, and provides means for expanding a hose by safely and efficiently heating the hose for insertion of a stem, fitting, or other attachment. The aforementioned hose assembly allows an operator to heat an individual hose or multiple hoses safely, without the hazards associated with the use of boiling water, flames, and other sources of heat.

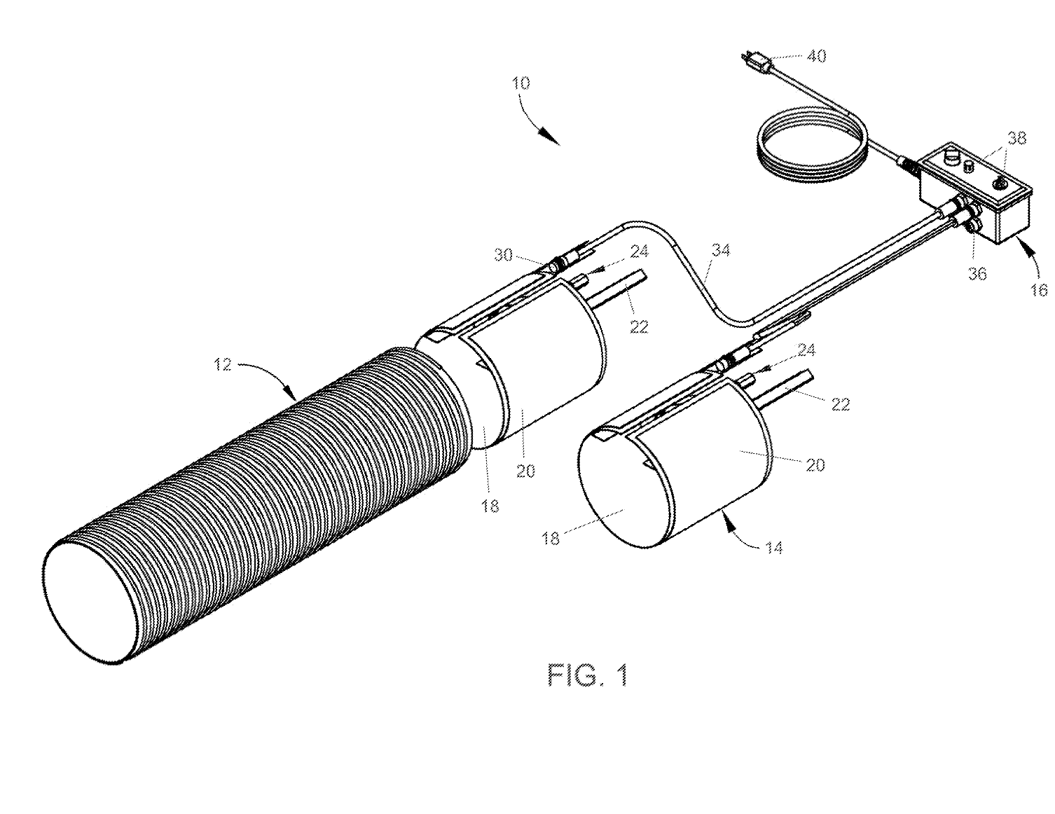

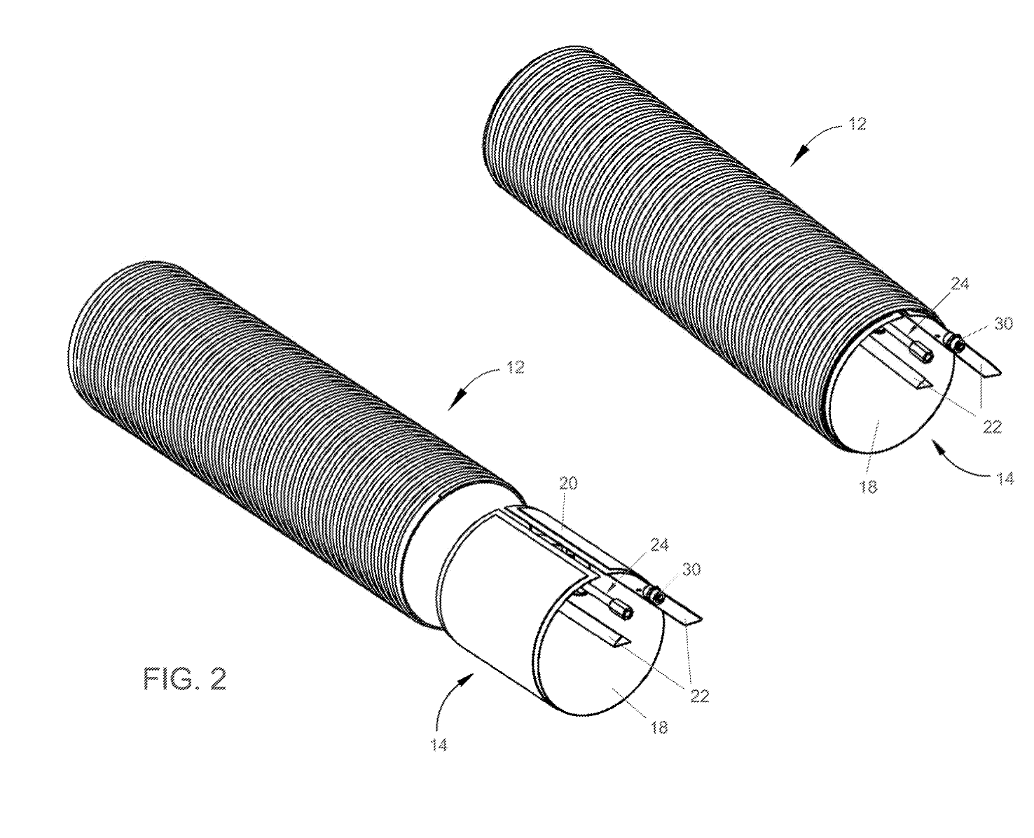

FIG. 1 represents a heating assembly 10 in accordance with an aspect of the invention. The assembly 10 is represented as including two hose heaters 14, each comprising an electric heating element 18, preferably a flexible resistive heater, and a rolled sleeve 20. The heating element 18 is wrapped around or within the sleeve 20, which is sized to be compatible with an industrial hose 12 that requires insertion of a stem, fitting, or other attachment (not shown). The sleeve 20 may support the heating element 18 and define an exterior shape of the hose heater 14. FIG. 2 represents the hose heater 14 prior to insertion into the hose 12 and after insertion into the hose 12. The heating element 18, when inserted into the hose 12, can preferably provide uniform heat conduction to an interior surface of one end the hose 12.

The hose heater 14 is configured to collapse in diameter to fit securely inside the hose 12 and then be released to contact a maximum amount of inner surface area within one end of the hose 12. The hose heater 14 comprises a gap along its axial or longitudinal length that provides the hose heater 14 with the ability to collapse, release, and expand in diameter. Upon releasing the hose heater 14 within the hose 12, the hose heater 14, preferably through the sleeve 20, exerts a physical force or pressure on the inner surface area inside the end of the hose 12. This physical force improves the thermal contact between the hose heater 14 and the hose 12 and further may promote expansion of the diameter of the hose 12 during heating. The hose heater 14 may be removed when a desired temperature of the hose 12 is reached, preferably prior to inserting the attachment.

In particular, the hose heater 14 is designed to heat the hose 12 to a desired temperature so that upon reaching the desired temperature, the hose 12 softens and expands to allow for insertion of the attachment into the hose 12. The size and shape of the hose heater 14 may be configured to be compatible with specific hoses and attachments developed for particular applications. FIG. 1 represents each hose heater 14 comprising support members 22 secured to the heating element 18, and an expansion assembly 24. If necessary, the expansion assembly 24 may be used to promote expansion of the end of the hose 12 during heating. The hose heater 14 is further represented as comprising an electrical connection 30 adapted to received electricity from a power source in order to heat the heating element 18. The electrical connection 30 is electrically connected by electrical cords 34 to a controller 16 adapted to regulate the temperature of the hose heaters 14. The controller 16 comprises electrical ports 36, controls 38, and a cord 40. In addition, the support members 22 may include an insulated material, such as a heat resistant polymer or rubber, on a surface of the support members 22 to provide hand grips for the operator to safely insert and remove the hose heaters 14 from the hose 12.

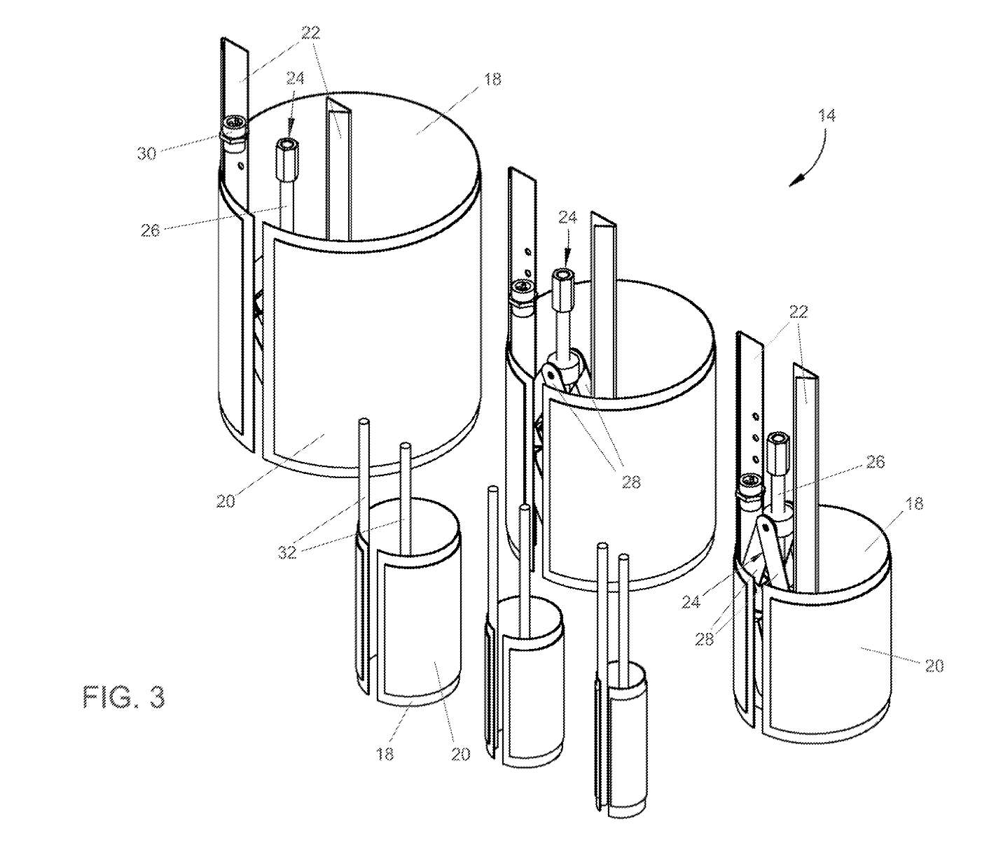

FIG. 3 represents multiple non-limiting embodiments of the hose heater 14. The heating element 18 of three hose heaters 14 adapted to mate with hoses 12 with relatively large inner diameters are represented as being secured to the support members 22. The support members 22 provide a platform for the expansion assembly 24 adapted to expand the inner diameter of the hose 12 once the hose 12 has reached the predetermined temperature or during the heating process. Preferably, the expansion of the hose 12 is elastic deformation. It is believed that significant plastic deformation may present problems when the attachment is secured to the hose 12, such as difficulties in a crimping process. The expansion assembly 24 may be constructed in any manner known in the art suitable for expanding the hose 12. For example, each of the three expansion assemblies 24 represented in FIG. 3 comprises a positioning component 26, for example, a threaded bolt, mechanically connected to a plurality of arms 28 that are pivotably attached to the hose heater 14. With this arrangement, the positioning component 26 can be rotated in a first direction to pivot and extend the arms 28 and in a second direction to pivot and contract the arms 28, thereby expanding and contracting the outer diameter of the hose heater 14, respectively, that is, increasing and decreasing the width of the gap along the longitudinal length of the hose heater 14.

The above-described expansion assembly 24 and support members 22 may be too large to be utilized in hose heaters 14 adapted to mate with hoses 12 with relatively small inner diameters. Therefore, FIG. 3 represents three smaller hose heaters 14, each comprising a pair of electrical leads 32 adapted to receive electricity from a power source in order to heat the heating element 18. It is believed that thermal expansion due to the heat emitted by the heating element 18 causes enough expansion in smaller diameter hoses for insertion of attachments. However, hose heaters 14 of all sizes may comprise any combination of the support members 22, the expansion assembly 24, the electrical connection 30, and the electrical leads 32.

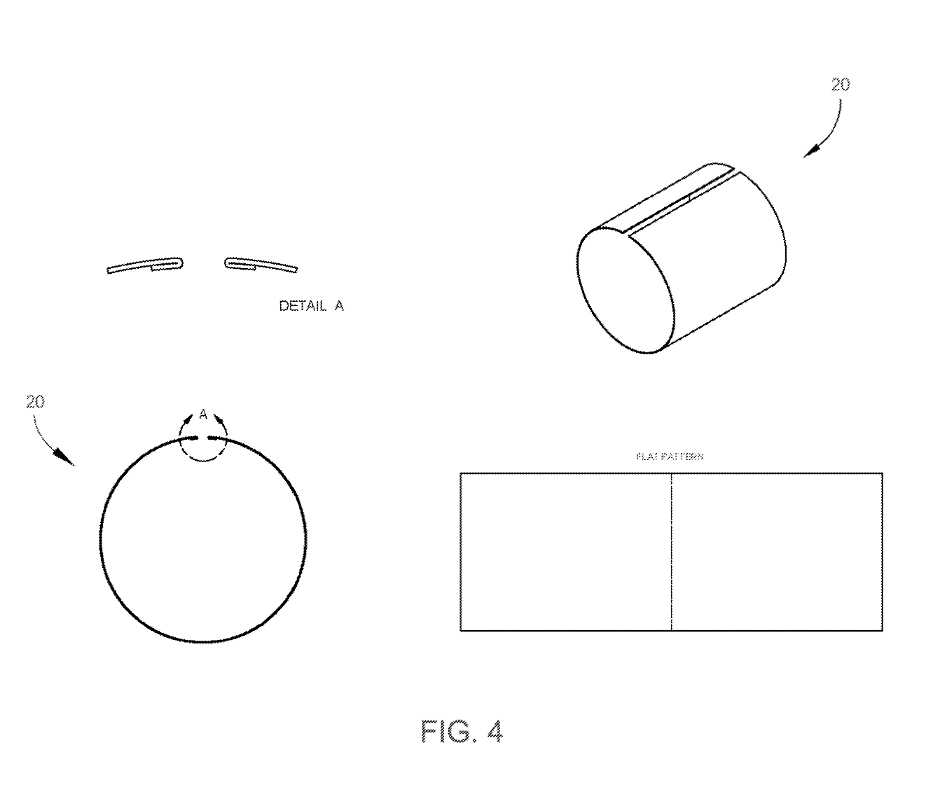

FIG. 4 includes isolated views representing the rolled sleeve 20. As represented, the rolled sleeve 20 may be formed from a flat pattern into a cylinder shape comprising a space or gap between opposing ends of the flat pattern to allow the rolled sleeve 20 to contract to decrease its outer diameter for insertion into the hose 12, and then expand within the hose 12. The opposing ends of the rolled sleeve 20 may be bent inward as represented or otherwise modified to avoid sharp edges. Although the rolled sleeve 20 is represented as being cylindrical in shape, it within the scope of this invention that the rolled sleeve 20 can have other shapes that conform to a hose or enable the sleeve 20 to shape a hose during expansion to mate with attachments of similar shape. The sleeve 20 may be formed of any suitable material known in the art.

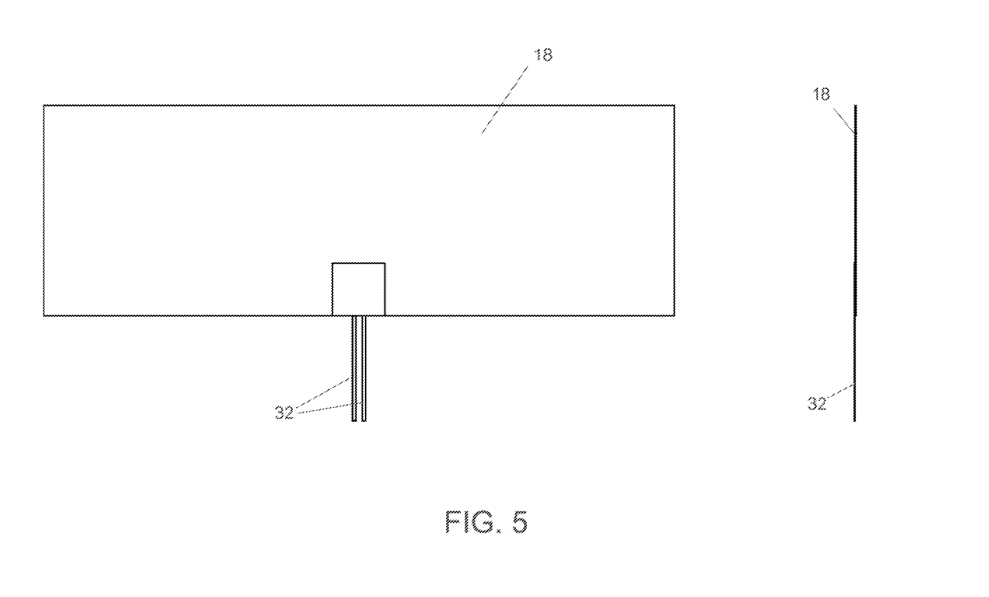

FIG. 5 represents the heating element 18 laid flat and comprising the pair of electrical leads 32 electrically connected to the heating element 18. The heating element 18 may be any type of heating element suitable for heating the hose 12. As previously stated, the heating element 18 is preferably a flexible resistive heat source that heats the hose 12 through conduction, a non-limiting example being a silicone rubber heater such as those produced by the Tempco Electric Heater Corporation located in Wood Dale, Ill.

The heating assembly 10 can allow for one hose 12 to be heated at a time, or multiple hoses 12 at a time. FIG. 1 represents the assembly 10 as a multiple heating station adapted to heat up to four hoses 12 simultaneously. Individual hose heaters 14 may be connected to a controller 16 by the electrical cords 34. Each electrical cord 34 may connect the electrical connection 30, electrical leads 32, or other means of electrical contact of one or more of the hose heaters 14 to one or more of the electrical ports 36 on the controller 16.

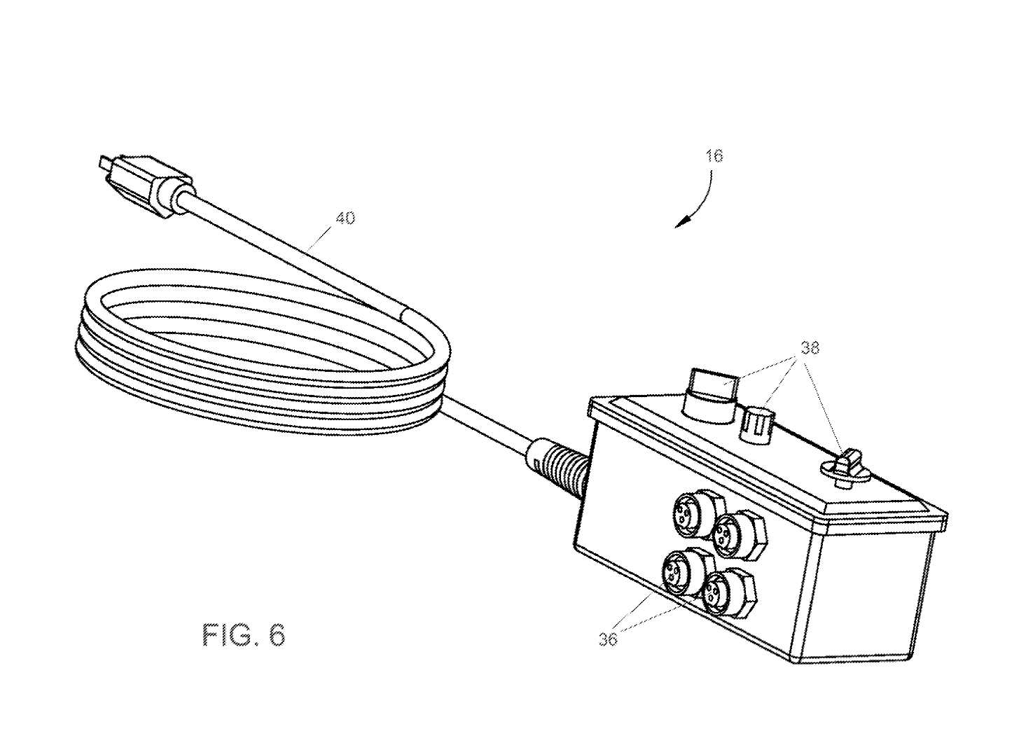

The controller 16 preferably allows for simple and safe operation of the heating assembly 10. The operator can use the controls 38, located on the controller 16, to regulate the temperature of the electric heating element 18 and achieve the predetermined temperature of the inner surface of one end of the hose 12. The controller 16 is represented as comprising the cord 40 adapted to electrically connect directly to a wall outlet and provide power to the controller 16, although other power supply connections are foreseeable and within the scope of the invention. FIG. 6 represents an isolated view of the controller 16. Preferably, the controller 16 is adapted to accommodate for heat loss. For example, the heat necessary to adequately increase the temperature of the hose 12 will depend on the size, thickness, and material of the particular hose 12. Therefore, the heating element 18 preferably is adapted to operate at a temperature above the desired temperature of the hose 12. An operational temperature of the heating element 18 may be determined by the operator or predetermined by the controller 16. In addition, larger heating elements 18 may require more energy in order to reach the desired operational temperature and, therefore, are preferably adapted to operate with larger amounts of power than smaller heating elements 18 to ensure consistency.

In view of the above, it can be seen that a significant advantage of this invention is that means for heating an industrial hose for insertion of a stem, fitting, or other attachment is disclosed which provides for enhanced safety to an operator while effectively heating the hose to the desired temperature.

While the invention has been described in terms of specific embodiments, it is apparent that other forms could be adopted by one skilled in the art. For example, the physical configuration of the hose heater 14, the controller 16, and the industrial hose assembly 10 could differ from that shown, and materials and processes other than those noted could be used. Therefore, the scope of the invention is to be limited only by the following claims.

1. A heating assembly for inserting an attachment into an end of a hose, the heating assembly comprising:
at least one hose heater comprising an electric heating element, wherein the hose heater is adapted to be collapsed, inserted into an end of the hose, and expanded to increase the temperature of the end of the hose.

2. The heating assembly of claim 1, wherein expansion of the hose heater causes a physical force to be applied to an inner surface of the end of the hose.

3. The heating assembly of claim 2, wherein the physical force is applied by a sleeve.

4. The heating assembly of claim 1, wherein the hose heater comprises a sleeve that supports the heating element.

5. The heating assembly of claim 1, wherein the hose heater is adapted to elastically expand the end of the hose to a predetermined diameter.

6. The heating assembly of claim 1, wherein the hose heater is adapted to reshape the end of the hose.

7. The heating assembly of claim 1, wherein the hose heater comprises a gap along the longitudinal length of the hose heater and an expansion assembly connected to the hose heater adapted to increase and/or decrease the width of the gap.

8. The heating assembly of claim 7, wherein the expansion assembly comprises a positioning component mechanically connected to a plurality of arms that are pivotably secured to the hose heater.

9. The heating assembly of claim 1, further comprising a controller adapted to regulate the temperature of the electric heating element.

10. The heating assembly of claim 9, wherein the controller is adapted to cause the heating element to be at a temperature that is higher than a predetermined temperature of the hose.

11. The heating assembly of claim 1, wherein the electric heating element comprises a silicone rubber heater.

12. A method of inserting an attachment into an end of a hose, the method comprising:
applying a source of heat to an inner surface of the end of the hose to cause thermal expansion thereof and applying a physical force to the inner surface of the end of the hose to cause physical expansion thereof resulting in expansion of the end of the hose to an inner diameter sufficient to mate with the attachment; and
inserting the attachment into the end of the hose.

13. The method of claim 12, wherein the physical expansion results in the end of the hose being reshaped to be similar to the shape of the attachment.

14. The method of claim 12, further comprising regulating the temperature of the source of heat.

15. A method of inserting an attachment into an end of a hose, the method comprising:
collapsing a hose heater comprising an electric heating element;
inserting the hose heater into the end of the hose;
releasing the hose heater causing the hose heater to apply a physical force to the inner surface of the end of the hose, wherein the electric heating element thermally contacts an inner surface of the end of the hose;
heating the hose with the electric heating element;
removing the hose heater from the hose; and
inserting the attachment into the end of the hose.

16. The method of claim 15, wherein the physical force applied to the inner surface of the end of the hose during heating of the hose is sufficient to expand the diameter of the end of the hose.

17. The method of claim 16, wherein the hose heater comprises a gap along the longitudinal length of the hose heater and the physical force is applied by increasing the width of the gap.

18. The method of claim 16, wherein the expansion of the diameter of the end of the hose results in the hose being reshaped to be similar to the shape of the attachment.

19. The method of claim 15, further comprising regulating the temperature of the electric heating element.

20. The method of claim 19, further comprising controlling the heating element to operate at a temperature that is higher than a desired temperature of the hose.
